(19) United States
(12) Patent Application Publication
(10) Pub. No.: US 2025/0341497 A1
(43) Pub. Date: Nov. 6, 2025

(54) DIGITAL TWIN SCENARIOS MOVING SCANNING DEVICE

(71) Applicant: East China Jiaotong University, Nanchang (CN)

(72) Inventors: Yingyao Cheng, Nanchang (CN); Wentao Hu, Nanchang (CN); Haiyang Zhuang, Nanchang (CN); Yalong Jiang, Nanchang (CN); Jie Fu, Nanchang (CN); Zhen Cui, Nanchang (CN); Yu Hu, Nanchang (CN); Xudong Chen, Nanchang (CN); Tao Jiang, Nanchang (CN); Bentong Zha, Nanchang (CN); Wentao Shu, Nanchang (CN); Xinzhe You, Nanchang (CN); Yuxiang Yuan, Nanchang (CN)

(73) Assignee: East China Jiaotong University, Nanchang, JX (CN)

(21) Appl. No.: 19/273,103

(22) Filed: Jul. 17, 2025

(30) Foreign Application Priority Data
Feb. 20, 2025 (CN) 202510187613.9

(51) Int. Cl. G01N 29/265; F16H 19/04; F16H 37/06; G01N 29/04

(52) U.S. Cl. CPC G01N 29/265; G01N 29/04; F16H 19/04; F16H 37/065

(57) ABSTRACT

The present disclosure relates to the technical field of scanning devices, and specifically discloses a digital twin perspective mobile scanning device, comprising a left bearing frame, a right bearing frame, a longitudinal clamping mechanism, a transverse adjustment mechanism, a driving mechanism, and a centering mechanism; the left bearing frame and the right bearing frame are connected and can move horizontally relative to each other, the longitudinal clamping mechanism is arranged at top ends of the left bearing frame and the right bearing frame, the centering mechanism is disposed between the left bearing frame and the right bearing frame, the transverse adjustment mechanism is arranged on the left bearing frame and the right bearing frame, the driving mechanism is arranged on the right bearing frame. The present disclosure adopts the digital twin perspective mobile scanning device and has high flexibility and adaptability to different building structure sizes, reduces the requirement of manual propulsion, realizes autonomous movement of the device, shortens the operation preparation time, and significantly improves the operation efficiency.

### TECHNICAL FIELD

The present disclosure relates to the technical field of scanning devices, in particular to a digital twin perspective mobile scanning device.

### BACKGROUND

Mobile scanning devices are primarily used for capturing perspective and acquiring data in three-dimensional space, and they are widely employed in architecture, engineering, and scientific research. A ‘digital twin’ scanning device is a mobile scanning device comprising one or more scanning heads, mobile platforms, and data processing units. In outdoor application perspective such as bridge inspection, the device is used to collect geometric and physical parameters of structures for subsequent analysis and modeling. The device usually uses a crawler, wheeled, or walking robot as a mobile platform to adapt to different terrain and environmental conditions. Early digital twin mobile scanning devices have achieved certain results in data acquisition accuracy and operation efficiency, but there are still some drawbacks in scanning complex or large structures due to limited mobility.

Nowadays, in complex inspection perspective such as bridge inspection, many perspective lack sufficient adaptability to deal with structures of different sizes and shapes, such as bridge cable structures, arch bridge structures, etc., resulting in the need to frequently adjust the position and angle of equipment during the scanning process, which is not only time-consuming but also may affect the consistency of data. In addition, existing devices have insufficient scanning accuracy and poor data consistency during movement: a non-centered scanner cannot guarantee symmetry of bridge components, which will cause errors when comparing and analyzing the data on opposite sides of a bridge, for example. Inconsistent scanning parameters such as distance, angle, and pressure will affect subsequent data analysis and processing, increase processing complexity and error rate, and miss important data. It is necessary to manually adjust the scanner position frequently, which increases the workload of operators and reduces the operation efficiency.

### SUMMARY

The present disclosure aims to provide a digital twin perspective mobile scanning device, which is convenient for adjusting the position and angle of equipment, enhancing data consistency, improving operation efficiency, and reducing the workload of operators.

In order to realize the above purpose, the present disclosure provides a digital twin perspective mobile scanning device, including a left bearing frame, a right bearing frame, a longitudinal clamping mechanism, a transverse adjustment mechanism, a driving mechanism, and a centering mechanism. The left bearing frame and the right bearing frame are connected and can move horizontally relative to each other. The longitudinal clamping mechanism is arranged at top ends of the left bearing frame and the right bearing frame. The centering mechanism is disposed between the left bearing frame and the right bearing frame. The transverse adjustment mechanism is arranged on the left bearing frame and the right bearing frame. The driving mechanism is arranged on the right bearing frame.

In some embodiments, both the left bearing frame and the right bearing frame are connected to bottom rollers in a manner of rotation.

In some embodiments, the longitudinal clamping mechanism includes longitudinal limit guide rods, a fixing seat, and an adjusting screw. Two longitudinal clamping mechanisms are provided, a mounting frame is provided on the longitudinal clamping mechanism, and the longitudinal limit guide rods are respectively arranged at top ends of the left bearing frame and the right bearing frame with two longitudinal limit guide rods every group, and the longitudinal limit guide rods are inserted into the mounting frame. A plurality of fixing seats are fixedly arranged on inner sides of the left bearing frame and the right bearing frame respectively. The adjusting screw is respectively connected to a plurality of fixing seats, and a top end of the adjusting screw is connected to the mounting frame in a manner of rotation.

In some embodiments, a top roller is provided on an inner side of the mounting frame. The top roller is connected to the mounting frame in a manner of rotation.

In some embodiments, the transverse adjustment mechanism includes a screw rod, a hinge seat, a rotating rod, and a transmission assembly, ends of the rotating rod and the two screw rods are provided with a transmission assembly, one end of the two screw rods is connected to the right bearing frame in a manner of rotation and extends to an outer side of the right bearing frame, and the other end is in a threaded connection with the left bearing frame. The hinge seat is fixedly installed on the outer side of the right bearing frame. The rotating rod is connected to the hinge seat in a manner of rotation, and two ends of the rotating rod are respectively provided with rotating handles. The transmission assembly is installed at ends of the rotating rod and the screw rod.

In some embodiments, the transmission assembly includes worm gears and spiral teeth. The number of the worm gears is two, and the worm gear is fixedly installed at an end of the screw rod. The number of the spiral teeth is two, and the spiral teeth are sleeved on the rotating rod and meshed with the worm gears.

In some embodiments, the driving mechanism includes a sleeve, a prism, a driving motor, a driving gear, and a driven gear. One end of the sleeve is connected through the left bearing frame and the bottom roller. The prism is inserted into the other end of the sleeve and connected to the bottom roller located on the right bearing frame in a manner of rotation. The driving motor is mounted on the right bearing frame and connected to the bottom roller. The driving gear is sleeved on the output end of the driving motor. The driven gear is sleeved on the prism and meshed with the driving gear.

In some embodiments, a sprocket is mounted on the bottom roller, and the sprocket is coaxial with the bottom roller. Chains are sleeved between the two sprockets located on the left bearing frame and the two sprockets located on the right bearing frame.

In some embodiments, the centering mechanism includes a base, a connecting rod, a first rack, a mounting plate, and a rotating gear, and a plurality of the bases are fixedly arranged at the bottom ends of the left bearing frame and the right bearing frame, respectively. Both ends of the connecting rod are respectively connected to two bases. The number of the connecting rods is two, and one end of the first rack is vertically connected to one of the connecting rods. One end of a second rack is vertically connected to the other connecting rod and is mutually parallel to the first rack. The mounting plate is movably connected to the first rack and the second rack, and an ultrasonic scanner is connected to a middle part. The rotating gear is mounted on the inner side of the mounting plate and meshes with each other with the first rack and the second rack, respectively.

Therefore, the present disclosure adopts the digital twin perspective mobile scanning device, and has the following beneficial effects:

(1) Through the flexibility of the longitudinal clamping mechanism and the transverse adjustment mechanism, the present disclosure significantly improves the adaptability to bridge components of different sizes, so that the device can maintain the stable positioning of the ultrasonic scanner when moving on the bridge surface, and obtain the parameter data required by the digital twin technology with the best positive centering position.

(2) The use of the driving mechanism of the present disclosure reduces the requirement of manual propulsion, realizes the autonomous movement of the device, significantly improves the operation efficiency, the device can quickly adapt to the sizes of different bridge structures, shorten the operation preparation time and improve the operation efficiency.

### BRIEF DESCRIPTION OF THE DRAWINGS

FIG. 1 is a schematic diagram of an overall three-dimensional structure of an embodiment of a digital twin perspective mobile scanning device according to the present disclosure;

FIG. 2 is a schematic structural diagram of a driving motor of an embodiment of a digital twin perspective mobile scanning device according to the present disclosure;

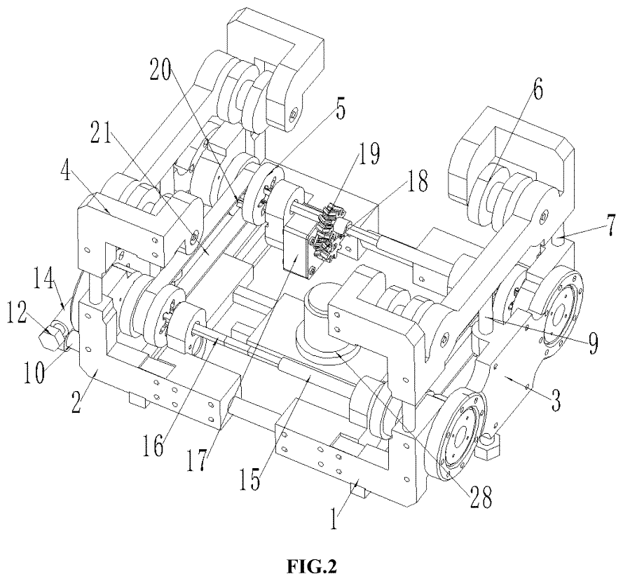

FIG. 3 is a schematic diagram of a three-dimensional structure of a centering mechanism according to an embodiment of a digital twin perspective mobile scanning device according to the present disclosure;

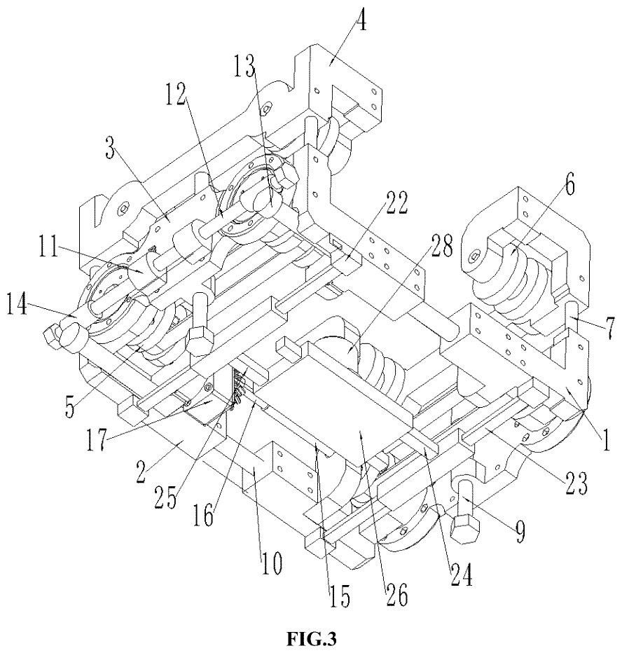

FIG. 4 is a front view of an embodiment of a digital twin perspective mobile scanning device according to the present disclosure;

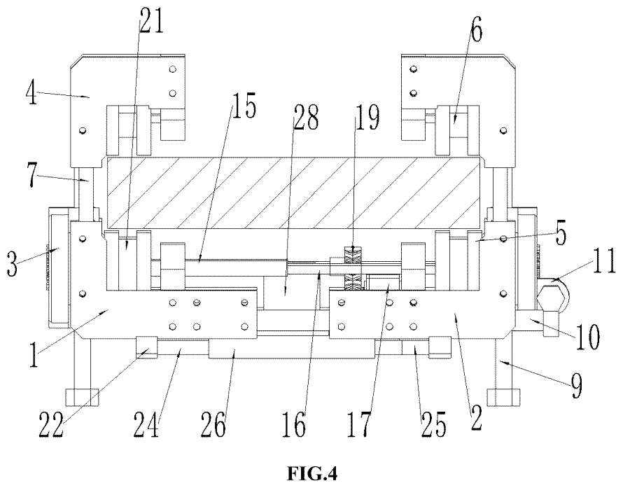

FIG. 5 is a cross-sectional view of the first gear of an embodiment of a digital twin perspective mobile scanning device according to the present disclosure;

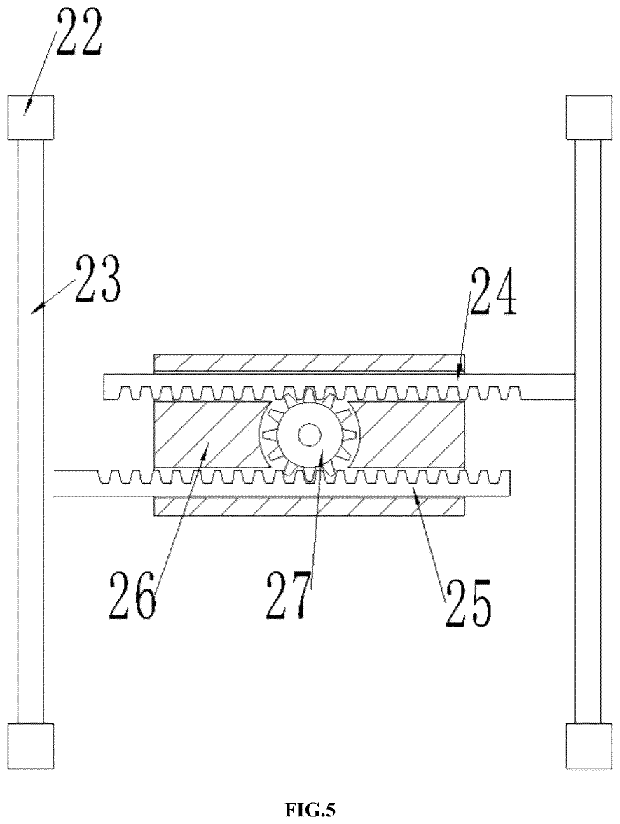

FIG. 6 is a bottom view of an embodiment of a digital twin perspective mobile scanning device according to the present disclosure.

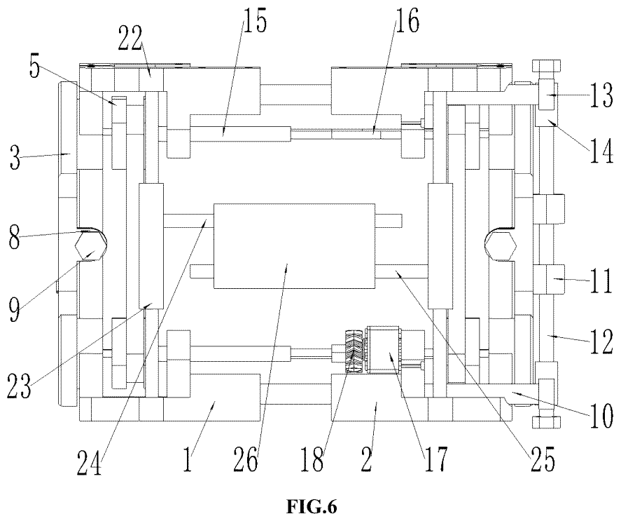

Marks in the FIGS.
1, left bearing frame; 2, right bearing frame; 3, connecting plate; 4, mounting frame; 5, bottom roller; 6, top roller; 7, longitudinal limit guide rod; 8, fixing seat 9, adjusting screw; 10, screw rod; 11, hinge seat; 12, rotating rod, 13, worm gear 14, spiral teeth; 15, sleeve; 16, prism; 17, driving motor; 18, driving gear; 19, driven gear; 20, sprocket; 21, chain; 22, base; 23, connecting rod; 24, first rack; 25, second rack; 26, mounting plate; 27, rotating gear; 28, ultrasonic scanner.

### DETAILED DESCRIPTION OF THE EMBODIMENTS

Hereinafter, the technical solution of the present disclosure will be further described concerning the accompanying drawings and examples.

Unless otherwise defined, technical terms or scientific terms used herein should have their usual meanings as understood by those of ordinary skill in the art to which this present disclosure belongs.

### EMBODIMENT

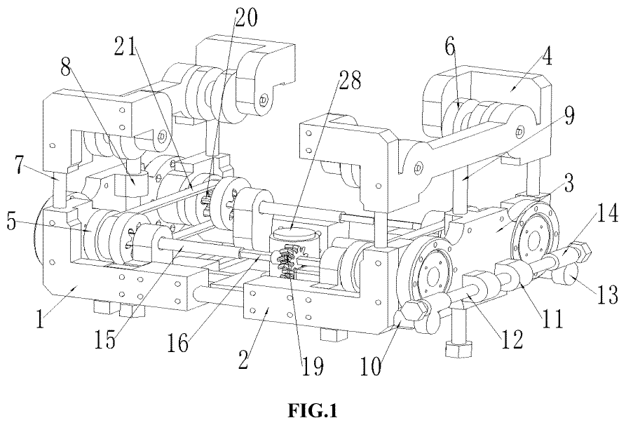

As shown in FIG. 1, a digital twin perspective mobile scanning device, including a left bearing frame 1, a right bearing frame 2, a longitudinal clamping mechanism, a transverse adjustment mechanism, a driving mechanism, and a centering mechanism. The left bearing frame 1 and the right bearing frame 2 are capable of relative horizontal movement. The longitudinal clamping mechanism is arranged at top ends of the left bearing frame 1 and the right bearing frame 2. The transverse adjustment mechanism is arranged on the left bearing frame 1 and the right bearing frame 2, and the driving mechanism is arranged on the right bearing frame 2. The centering mechanism is disposed between the left bearing frame 1 and the right bearing frame 2. Both the left bearing frame 1 and the right bearing frame 2 are connected to bottom rollers 5 in a manner of rotation.

The longitudinal clamping mechanism includes a longitudinal limit guide rod 7, a fixing seat 8, and an adjusting screw 9. A mounting frame 4 is arranged on the longitudinal clamping mechanism, a plurality of longitudinal limit guide rods 7 are respectively arranged at the top ends of the left bearing frame 1 and the right bearing frame 2 with two longitudinal limit guide rods every group, and are movably inserted with the two mounting frames 4, allowing the mounting frame 4 to realize longitudinal movement along the longitudinal limit guide rod 7. A plurality of fixing seats 8 are fixedly arranged on the inner sides of the left bearing frame 1 and the right bearing frame 2 respectively, and the fixing seats 8 provide fixed connection points for the adjusting screw 9. The two adjusting screws 9 are screwed with a plurality of fixing seats 8 respectively, and the top ends of the adjusting screws are connected with the two mounting frames 4 in a manner of rotation.

When controlling the distance between the two mounting frames 4 and the left bearing frame 1 and the right bearing frame 2, the longitudinal distance between the mounting frame 4 and the bearing frame can be adjusted by rotating the adjustment screw 9 under the restriction of the thread of the adjustment screw 9, so as to adapt to bridge components of different thicknesses. So that the longitudinal clamping mechanism can be flexibly adjusted to adapt to bridge structures of different sizes, and the scanning device can be stably fixed on the bridge component for scanning operation.

The transverse adjustment mechanism includes a screw rod 10, a hinge seat 11, a rotating rod 12, and a transmission assembly, one end of the two screw rods 10 is rotatably connected with the right bearing frame 2 and extends to the outer side of the right bearing frame 2, and the other end is screwed with the left bearing frame 1, allowing the screw rod 10 to adjust the distance between the left bearing frame 1 and the right bearing frame 2 when rotating. The two hinge seats 11 are respectively fixedly installed on the outside of the right bearing frame 2, and the two hinge seats 11 are used as supporting points of the rotating rod 12. The rotating rod 12 can be rotatably installed on the two hinge seats 11 along its own axis in a manner of rotation, and two ends of the rotating rod 12 are respectively installed with rotating handles, which is convenient for the operator to rotate manually; The transmission assembly is mounted on the ends of the rotary rod 12 and the two screw rods 10.

The function of the transmission assembly is to transmit the rotating motion of the rotating rod 12 to the screw rod 10, and under the restriction of the thread of the screw rod 10, the adjustment of the distance between the left and right bearing frames 2 may be realized. When it is necessary to adjust the distance between the two mounting frames 4 and the distance between the two bearing frames, the operator rotates the rotating handle, so that the rotating rod 12 rotates, and then drives the transmission assembly, the transmission assembly transmits the rotating motion to the screw rod 10, the rotation of the screw rod 10 causes the distance between the left bearing frame 1 and the right bearing frame 2 to change, so as to realize the transverse adjustment function to adapt to different widths of bridge components for clamping and fixing.

The transmission assembly includes worm gears 13 and spiral teeth 14, and the two worm gears 13 are respectively fixedly installed at the ends of the two screw rods 10. The two worm teeth 14 are respectively provided on the outer side of the outer wall of the rotating member, and mesh with the two worm gears 13.

When the rotating handle on the rotating rod 12 is rotated by the operator, the spiral teeth 14 rotate accordingly. Because the spiral teeth 14 and the worm gears 13 mesh, the rotational power is transmitted to the worm gear 13, which eventually drives the screw rod 10 to rotate. The rotation of the screw 10 further causes the distance between the left bearing frame 1 and the right bearing frame 2 to change, thereby achieving the transverse adjustment function. The meshing transmission of the worm gears 13 and the spiral teeth 14 realizes transverse adjustment, which significantly improves the adaptability and accuracy of bridge scanning. The distance between the left bearing frame 1 and the right bearing frame 2 is allowed to be adjusted to adapt to different widths of bridge components, ensuring that the scanning device can be stably fixed on the bridge for scanning operations. It is easy to operate, and the transverse adjustment can be realized only by manually turning the handle, which reduces the technical requirements of the operator and improves the work efficiency.

The driving mechanism includes a sleeve 15, a prism 16, a driving motor 17, a driving gear 18, and a driven gear 19, and one end of the two sleeve 15 is respectively fixedly connected on the roller 5 located at the bottom of the left bearing frame 1. The two prisms 16 can be moved in the horizontal direction respectively and are inserted in the other ends of the two sleeves 15, and the prisms are in a transmission connection with the bottom roller 5 located on the right bearing frame 2. The driving motor 17 is mounted on the right bearing frame 2. The driving gear 18 is sleeved on the drive end of the driving motor 17. The driven gear 19 is sleeved outside the outer walls of the two prisms 16 and meshes with the driving gear 18.

When the bridge component needs to be scanned, the driving motor 17 is controlled to start, the driving gear 18 at the driving end is driven to rotate, and the power is transmitted to the driven gear 19 through meshing, so as to make the prism 16 rotate, and finally the rotating power is transmitted to the bottom roller 5, the bottom roller 5 is in contact with the surface of the bridge component, and the bridge component is forcefully clamped under the action of the adjusting screw 9, so as to realize the autonomous movement of the left bearing frame 1 and the right bearing frame 2 on the bridge component. By starting the driving motor 17, automatic movement of the device on the bridge component is realized, and manual operation is significantly reduced, thereby improving the operation efficiency. By controlling the driving motor 17 and the gear to mesh, the movement of the bottom roller 5 can be controlled to ensure the stability and accuracy of the scanning process. The force of the adjusting screw 9 ensures the strong clamping of the bridge component by the device, and ensures the stability in the moving process. The connection of the prism 16 and the sleeve 15 enables the device to move in two directions, increasing the flexibility of the operation. The autonomous movement capability ensures continuous scanning of bridge components, providing continuous and comprehensive data support for the digital twin model. The manual intervention is reduced, the operation risks are reduced and the safety of workers is guaranteed.

The plurality of bottom rollers 5 are also provided with sprockets 20, and the plurality of sprockets 20 are respectively arranged on the plurality of bottom rollers 5 and are coaxial with the bottom rollers 5. Where chains 21 are sleeved between the two sprockets 20 located on the left bearing frame 1 and between the two sprockets 20 located on the right bearing frame 2.

When the driving motor 17 is started and drives the driving gear 18 to rotate, the power is transmitted to the sprocket 20 on the bottom roller 5 through the meshed driven gear 19. The sprocket 20 is arranged coaxially with the bottom roller 5, ensuring the direct transmission of power. Chains are sleeved between the two sprockets 20 located on the left bearing frame 1 and between the two sprockets 20 located on the right bearing frame 2, the chain 21 connects the sprockets 20 to form a closed loop. When the sprocket 20 rotates, the chain 21 also moves accordingly, and drives the bottom rollers 5 on the left and right bearing frames 2 to rotate synchronously. It is ensured that the movement of the left bearing frame 1 and the right bearing frame 2 on the bridge component is coordinated and can be maintained in synchronization whether it is advanced forward or retreated backward, thereby achieving a smooth movement of the device on the bridge component. Through the transmission mechanism of the chain 21 and the sprocket 20, stable scanning operations on bridge components can be achieved, providing continuous data support for the digital twin perspective.

The centering mechanism includes a base 22, a connecting rod 23, a first rack 24, a second rack 25, a mounting plate 26, and a rotating gear 27, and a plurality of bases 22 are fixedly arranged at the bottom ends of the left bearing frame 1 and the right bearing frame 2 respectively. Both ends of the two connecting rods 23 are respectively installed on a plurality of bases 22. The end portion of the first rack 24 is fixedly arranged on the outer side of the outer wall of one of the connecting rods 23, and is arranged perpendicularly to the connecting rod 23. The end of the second rack 25 is fixedly arranged on the outer side of the outer wall of the other connecting rod 23, and is mutually parallel to the first rack 24. The mounting plate 26 is sleeved on the outer side of the outer walls of the two first rack 24 and the second rack 25, and is movably connected to the first rack 24 and the second rack 25, and the middle part of the mounting plate 26 is connected to the ultrasonic scanner 28. A rotating gear 27 is mounted on the inner side of the mounting plate 26 in a manner of rotation and intermeshes with the first rack 24 and the second rack 25, respectively.

The connecting rod 23 is mounted on the base 22 to form a structure connecting the left bearing frame 1 and the right bearing frame 2. The mounting disk 26 is sleeved outside the outer walls of the two racks and is movably connected to the racks, allowing the mounting disk 26 to be moved in the direction of the racks. The middle part of the mounting tray 26 is connected to the ultrasonic scanner 28, ensuring that the position of the scanner can be adjusted with the movement of the mounting tray 26 and is always in the middle part of the device. When the distance between the left bearing frame 1 and the right bearing frame 2 is adjusted by the transverse adjustment device, the connecting rod 23 moves accordingly, at this time, the first rack 24 and the second rack 25 move synchronously under the action of the rotating gear 27, so as to ensure that the ultrasonic scanner 28 is always located in the middle part of the device and realize accurate scanning. The centering mechanism ensures the precise positioning of the ultrasound scanner 28 during the scanning process, improves the accuracy and efficiency of the scanning, and provides high-quality data support for the digital twin perspective.

The ultrasonic scanner 28 at all times in a centered position ensures symmetry with the bridge component for scanning operations of the bridge component, thereby improving scanning accuracy, which is essential for obtaining accurate and consistent scanning data, especially when data on both sides need to be compared. The centering position helps to maintain consistency in scanning parameters such as distance, angle, and pressure, which is important for subsequent data processing and analysis. The centered position allows the ultrasonic scanner 28 to effectively cover the central area of the bridge component, which is a critical area for structural health monitoring, optimizing the scanning range. The centering mechanism reduces the number of times that the scanner position needs to be adjusted during the scanning process, saving time and improving operation efficiency. The automated centering mechanism reduces the need to manually adjust the scanner position and reduces data bias caused by improper operation. Even when the width and thickness of bridge components or other building components vary, the centering mechanism ensures that the scanner is always in the center position, enhancing adaptability. The centering position also helps to reduce the influence of environmental factors on scan results and improve the reliability of data. The data obtained at the center position is easier to compare and analyze with bridge design drawings or other reference data, which is convenient for subsequent structural health assessment and maintenance decisions. The centered position of the ultrasonic scanner 28 not only improves the efficiency and accuracy of the scanning operation, but also provides high-quality data support for the digital twin perspective, which is of great significance for the health monitoring and maintenance of the bridge.

In this embodiment, when scanning the bridge components, the distance between the two mounting frames 4 and the left bearing frame 1 and the right bearing frame 2 is adjusted by manipulating the longitudinal clamping mechanism, and the distance between the top roller 6 and the bottom roller 5 is driven to change at the same time to adapt to the bridge components of different thicknesses. Wherein, both the left bearing frame 1 and the right bearing frame 2 are composed of a profile and a connecting plate 3, and the distance between the left bearing frame 1 and the right bearing frame 2 is adjusted by using a transverse adjustment mechanism to realize the clamping and fixing of bridge components with different widths. Subsequently, the driving mechanism is activated to drive the bottom roller 5 to move, thereby driving the left bearing frame 1 and the right bearing frame 2 to flexibly move on the bridge component, and in the process of moving scanning, the centering mechanism cooperates with the ultrasonic scanner 28 to continuously scan the bridge component, collect necessary data information, and provide data support for building a digital twin perspective; it also ensures that the device can adapt to different devices and bridge structures of different sizes, and efficiently complete scanning tasks during movement. The transverse adjustment mechanism ensures the fit between the centering mechanism and bridge components, further improving the flexibility and adaptability of the device to adapt to different building structure sizes. And the centering mechanism can quickly adapt to different bridge sizes, reduce operation preparation time, further improve operation efficiency, and provide strong technical support for digital twin perspective.

Therefore, the present disclosure adopts the digital twin perspective mobile scanning device, has high flexibility and adaptability to different building structure sizes, reduces the demand for manual propulsion, realizes autonomous movement of the device, shortens the operation preparation time, and significantly improves the operation efficiency.

Finally, it should be noted that the above embodiment is merely used to illustrate the technical scheme of the invention rather than to restrict it. Although the invention is described in detail concerning the better embodiment, ordinary technicians in this field should understand that they can still modify or replace the technical scheme of the invention, and these modifications or equivalent replacements cannot make the modified technical scheme out of the spirit and scope of the technical scheme of the invention.

What is claimed is:

1. A digital twin perspective mobile scanning device, comprising a left bearing frame, a right bearing frame, a longitudinal clamping mechanism, a transverse adjustment mechanism, a driving mechanism, and a centering mechanism;
wherein the left bearing frame and the right bearing frame are connected, and can move horizontally relative to each other,
wherein the longitudinal clamping mechanism is arranged at top ends of the left bearing frame and the right bearing frame, the centering mechanism is disposed between the left bearing frame and the right bearing frame, the transverse adjustment mechanism is arranged on the left bearing frame and the right bearing frame, and the driving mechanism is arranged on the right bearing frame;
wherein the transverse adjustment mechanism comprises a screw rod, a hinge seat, a rotating rod, and a transmission assembly,
wherein ends of the rotating rod and the two screw rods are provided with a transmission assembly, one end of the two screw rods is connected to the right bearing frame in a manner of rotation and extends to an outer side of the right bearing frame, and the other end is in a threaded connection with the left bearing frame, wherein the hinge seat is fixedly installed on the outer side of the right bearing frame, the rotating rod is connected to the hinge seat in a manner of rotation, and two ends of the rotating rod are respectively provided with rotating handles;
wherein the transmission assembly is installed at ends of the rotating rod and the screw rod;
wherein the centering mechanism comprises a base, a connecting rod, a first rack, a mounting plate, and a rotating gear, and a plurality of the bases are fixedly arranged at the bottom ends of the left bearing frame and the right bearing frame, respectively, both ends of the connecting rod are respectively connected to two bases;
wherein the number of the connecting rods is two, and one end of the first rack is vertically connected to one of the connecting rods, one end of a second rack is vertically connected to the other connecting rod and is mutually parallel to the first rack;
wherein the mounting plate is movably connected to the first rack and the second rack, and an ultrasonic scanner is connected at a middle part, and
wherein the rotating gear is mounted on the inner side of the mounting plate and meshes with each other with the first rack and the second rack, respectively.

2. The digital twin perspective mobile scanning device according to claim 1, wherein both the left bearing frame and the right bearing frame are connected to bottom rollers in a rotatable configuration.

3. The digital twin perspective mobile scanning device according to claim 2, wherein the longitudinal clamping mechanism comprises longitudinal limit guide rods, a fixing seat, and an adjusting screw,
wherein two longitudinal clamping mechanisms are provided, a mounting frame is provided on the longitudinal clamping mechanism, and the longitudinal limit guide rods are respectively arranged at top ends of the left bearing frame and the right bearing frame with two longitudinal limit guide rods every group, and wherein the longitudinal limit guide rods are inserted into the mounting frame, and a plurality of fixing seats are fixedly arranged on inner sides of the left bearing frame and the right bearing frame respectively; and
wherein the adjusting screw is connected to a plurality of fixing seats, and a top end of the adjusting screw is connected to the mounting frame in a rotatable configuration.

4. The digital twin perspective mobile scanning device according to claim 3, wherein a top roller is provided in an inner side of the mounting frame, and the top roller is connected to the mounting frame in a rotatable configuration.

5. The digital twin perspective mobile scanning device according to claim 4, wherein the transmission assembly comprises worm gears and spiral teeth, the number of the worm gears is two, and a worm gear is fixedly installed at an end of the screw rod, the number of the spiral teeth is two, and the spiral teeth are sleeved on the rotating rod and meshed with the worm gears.

6. The digital twin perspective mobile scanning device according to claim 5, wherein the driving mechanism comprises a sleeve, a prism, a driving motor, a driving gear, and a driven gear, one end of the sleeve is connected through the left bearing frame and the bottom roller,
wherein the prism is inserted into the other end of the sleeve and connected to the bottom roller located on the right bearing frame in a rotatable configuration, the driving motor is mounted on the right bearing frame and connected to the bottom roller, the driving gear is sleeved on the output end of the driving motor, the driven gear is sleeved on the prism and meshed with the driving gear.

7. The digital twin perspective mobile scanning device according to claim 6, wherein a sprocket is mounted on the bottom roller, and the sprocket is coaxial with the bottom roller, chains are sleeved between the two sprockets located on the left bearing frame, and the two sprockets located on the right bearing frame.
